(19) United States
(12) Patent Application Publication
(10) Pub. No.: US 2025/0314122 A1
(43) Pub. Date: Oct. 9, 2025

(54) DOOR SEAL FOR PREVENTING THE PASSAGE OF RODENTS

(71) Applicant: RENTOKIL INTIAL 1927 PLC, West Sussex (GB)

(72) Inventors: Craig Jones, Denbighshire (GB); Mark Brown, Prestatyn (GB); Emma Chisholm, Banbury (GB); Nikki Dexter, East Sussex (GB); Sam Plowman, East Sussex (GB)

(73) Assignee: RENTOKIL INTIAL 1927 PLC, West Sussex (GB)

(21) Appl. No.: 18/865,954

(22) PCT Filed: May 17, 2023
(86) PCT No.: PCT/GB2023/051292

§ 371 Date: Nov. 14, 2024

(30) Foreign Application Priority Data
May 17, 2022 (GB) 2207226.8

(51) Int. Cl. E06B 7/23

(52) U.S. Cl. CPC E06B 7/2314; E06B 7/2316

(57) ABSTRACT

A door seal for spanning a gap between a door and a surface adjacent to the edge of the door to prevent the passage of rodents is provided. The door seal is arranged to be mounted on an edge of the door. The door seal includes a flexible hollow cylinder formed of an elastomeric material, and a cylinder of knitted barrier material positioned inside the flexible hollow cylinder. The exterior surface of the cylinder of knitted barrier material is in contact with the interior surface of the flexible hollow cylinder.

### FIELD OF THE INVENTION

The present invention concerns door seals for preventing the passage of rodents. More particularly, but not exclusively, the invention concerns door seals for spanning a gap between a door of a building and a surface adjacent to the edge of the door, which are arranged to be mounted on an edge of the door. The present invention also concerns doors comprising door seals, and methods of mounting door seals on doors.

### BACKGROUND OF THE INVENTION

It is known to mount seals on the edges of doors of buildings to attempt to prevent the passage of rodents such as mice. An example door seal is disclosed in US 2014/0250788 A1 (Schild, Ill et al) published 11 Sep. 2014, in particular in FIG. 1D which refers to a “cushion-style” seal. The seal comprises a strip of outer material such as rubber, folded onto itself to form a teardrop shape. The seal has various internal layers including an “inner material”. In the context of other types of door seal, the document discusses the use of various woven and non-woven materials as the inner material, particularly materials comprising metal fibres in order to provide a gnaw-resistant barrier to rodents.

However, while materials comprising metal wire strands can provide some barrier to rodents, it has been found that particularly over an extended period rodents are nevertheless able to break through barriers formed of such materials. This is because while a rodent may not be able to chew through or other break the metal strands making up the inner material, they can nevertheless remove individual strands from the seal by pulling them away from the rest of the inner material. When a sufficient number of metal strands have been removed, an opening through the inner material is created through which rodents can pass. This is particularly the case where the inner material is a non-woven material formed by pressing a mass of metal fibres together, but is also the case for woven materials, from which individual strands can be removed.

The present invention seeks to solve or mitigate the above-mentioned problems. Alternatively and/or additionally, the present invention seeks to provide improved door seals, doors comprising door seals, and methods of mounting door seals on doors.

### SUMMARY OF THE INVENTION

In accordance with a first aspect of the invention there is provided a door seal for spanning a gap between a door and a surface adjacent to the edge of the door to prevent the passage of rodents, the door seal arranged to be mounted on an edge of the door, the door seal comprising:
a flexible hollow cylinder;
a cylinder of knitted barrier material positioned inside the flexible hollow cylinder, wherein the exterior surface of the cylinder of knitted barrier material is in contact with the interior surface of the flexible hollow cylinder.

By having the barrier material in the shape of a cylinder, the exterior surface of which is in contact with the interior surface of the flexible hollow cylinder, the barrier material covers the gap spanned by the door seal. Further, the barrier material is knitted, in other words it is formed from a single strand arranged into a spiral of rows that form the length of the cylinder, each row being arranged into loops which interlock with the loops in the rows above and below it. This means that a rodent is not able to remove any part of the cylinder of knitted barrier material from within the flexible hollow cylinder, i.e. a single strand, as the cylinder is formed from a continuous strand so no part of it can be separated from the rest. This differs from non-woven materials, which are formed from multiple usually short strands that are compressed together, and also from woven materials, which comprise a multiple separate strands in a first direction interleaved with multiple separate strands in a perpendicular direction.

Further, the use a cylinder of knitted barrier material allows the door seal to be conveniently manufactured, because the cylinder of knitted barrier material will reduce in diameter when it is stretched along its length. This means the door seal can be constructed using a cylinder of knitted barrier material that in its unstretched shape has a diameter large than that of the interior of the flexible hollow cylinder within which it is position. To manufacture the door seal, the cylinder of knitted barrier material is stretched so that its diameter reduces to be less than that of the interior of the flexible hollow cylinder, and while in the stretched state the cylinder of knitted barrier material is positioned within the flexible hollow cylinder. The cylinder of knitted barrier material is then released, and as it reduced in length again its diameter increases until it touches the interior surface of the flexible hollow cylinder. In this way, the cylinder of knitted barrier material remains in position within the flexible hollow cylinder due to friction only. Alternatively and/or additionally, the cylinder of knitted barrier material may be fixed within the flexible hollow cylinder by adhesive or other fixing means.

When mounting the door seal on an edge of the door, the door seal may be mounted directly on the end of the door facing the gap spanned by the door seal, or may be mounted a side of the door proximate to the end.

The flexible hollow cylinder may be a circular cylinder, or alternatively may be elliptical, teardrop or any other desired shape

The flexible hollow cylinder may be formed of an elastomeric material, or rubber, or any other suitable material.

The cylinder of knitted barrier material may be formed of metal wire. The metal may be stainless steel, or any other suitable metal or material. The cylinder of knitted barrier material may be formed from a single continuous strand of material, such as metal wire.

The door seal may further comprise a plug positioned in an opening at an end of the flexible hollow cylinder, wherein the corresponding end of cylinder of knitted barrier material is in contact with the exterior surface of the plug so that the knitted barrier material is held in position between the exterior surface of the plug and the interior surface of the flexible hollow cylinder. The door seal may further comprise a second plug positioned in the opening at the opposite end of the flexible hollow cylinder. The plug or plugs help to keep the cylinder of knitted barrier material in position within the flexible hollow cylinder.

The door seal may further comprise a first strip positioned on the exterior surface of the flexible hollow cylinder, and wherein the door seal is arranged to be fixed to the edge of the door by the first strip. The first strip may extend substantially or entirely along the length of the flexible hollow cylinder. The door seal may further comprise a fixing strip fixed to the first strip. The fixing strip may be formed of metal, for example aluminium, or any other suitable metal or material. The first strip may be clamped between two surfaces of the fixing strip. The fixing strip may comprise an area through which the door seal can be screwed to the door. The fixing strip may further comprise a layer of contact adhesive for gluing the door seal to the door. In this case, the door seal can be mounted on the door by first attaching the fixing strip to the door using the layer of contact adhesive, and then screwing one or more screws through the one or more holes of the fixing strip into the edge of the door.

The door seal may further comprise a second strip positioned on the exterior surface of the flexible hollow cylinder, wherein the door seal is further arranged to be fixed to the edge of the door by the second strip. In this way, the door seal can be mounted on the door using both the first strip and the second strip. The first strip and second strip may be fixed to opposite sides of the door, particularly in the case the door is very thin, for example a roller door. The first and strip may be positioned at the same position or very close on the exterior surface of the flexible hollow cylinder. The first and second strip may extend from the surface of the flexible hollow cylinder, for example to for a V-shape. The surface of the first strip facing the second strip may comprise a first layer of contact adhesive, and the surface of the second strip facing the first strip may comprise a second layer of contact adhesive.

The flexible hollow cylinder and the first planar portion and/or the second planar portion may be formed from the same piece of elastomeric material. The elastomeric material may be extruded.

In accordance with a second aspect of the invention there is provided a door having mounted on an edge a door seal as described above.

In accordance with a third aspect of the invention there is provided a method of mounted a door seal as described above to the edge of a door, comprising:
attaching the fixing strip of the door seal to the edge of the door using the layer of contact adhesive;
repositioning the fixing strip on the edge of the door; and
once the door seal is in the desired position, screwing one or more screws through the area of the fixing strip into the edge of the door.

The use of contact adhesive initially allows the door seal to be removed and repositioned if required, and then once in the desired position the door seal can be securely fixed in place by screwing the fixing strip to the door.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

FIG. 1 is a side view of a door seal in accordance with an embodiment of the present invention;

FIG. 2 is a perspective view of the door seal of FIG. 1;

FIG. 3 is a close-up view of a portion of a cylinder of knitted barrier material of the door seal;

FIG. 4 is a side view of a fixing strip of the door seal before incorporation into the door seal;

FIG. 5 is a photograph showing the door seal mounted on the edge of a door;

FIG. 6 is a flowchart showing a method of fixing the door seal to a door in accordance with an embodiment of the present invention;

FIG. 7 is a perspective view of an end cap for use with the door seal in accordance with an embodiment of the present invention;

FIG. 8 is a perspective view of an end of the door seal incorporating the end cap of FIG. 7;

FIG. 9 is a side view of an end of the door seal incorporating the end cap of FIG. 7;

FIG. 10 is a side view of a door seal in accordance with an embodiment of the present invention;

FIG. 11 is a perspective view of the door seal of FIG. 10;

FIG. 12 is a photograph showing the door seal mounted on the edge of a door;

FIG. 13 is a side view of a door seal in accordance with an embodiment of the present invention; and

FIG. 14 is a photograph showing the door seal of FIG. 13 mounted on the edge of a door.

### DETAILED DESCRIPTION

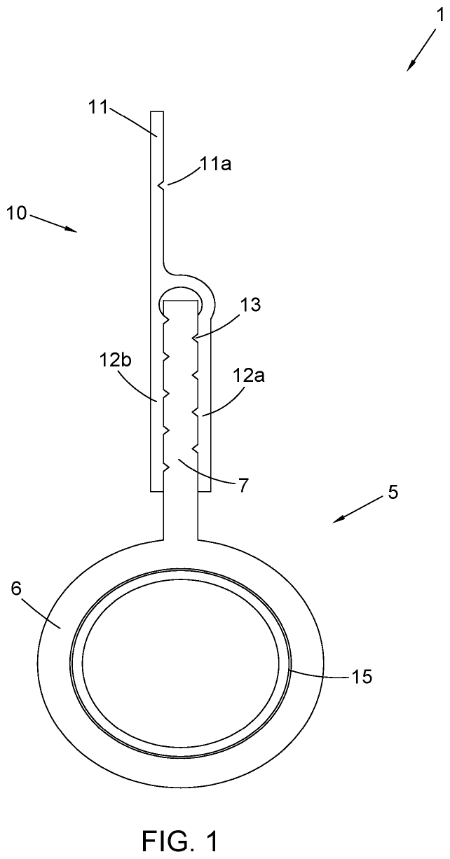

A door seal in accordance with an embodiment of the invention is now described with reference to FIGS. 1 to 5. The door seal 1 is arranged to be mounted on an edge of the door of a building, to span a gap between the door and a surface adjacent to the edge of the door, such as the ground, so that the door seal 1 prevents the passage of rodents.

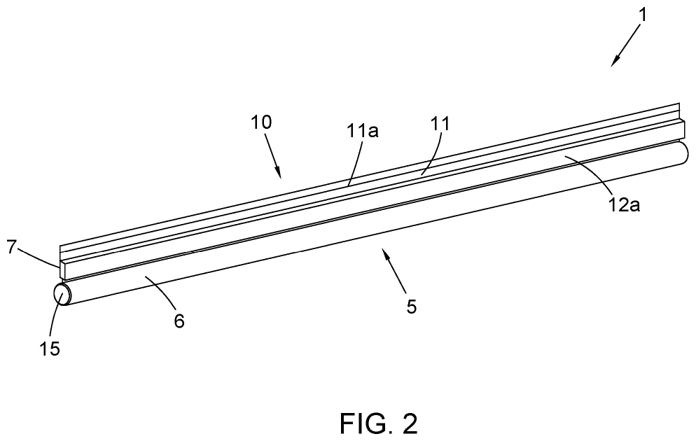

FIGS. 1 and 2 are side and perspective views of the door seal 1. The door seal 1 comprises a length of elastomeric material 5, which comprises a hollow cylinder 6, which has extending radially outwards from its surface a planar strip 7. In embodiments of the invention the length of elastomeric material 5 is extruded as a single piece, i.e. the hollow cylinder 6 and the planar strip 7 are formed together. In other embodiments the length of elastomeric material 5 may be formed in other ways, for example the hollow cylinder 6 and the planar strip 7 may be fixed together after being separately manufactured, and/or either or both parts may be formed by a method other than extrusion. In the present embodiment the length of elastomeric material 5 is formed of ethylene propylene diene monomer (EPDM) rubber, though in other embodiments other materials may be used.

Inside the hollow cylinder 6 is a knitted wire cylinder 15. The exterior surface of the knitted wire cylinder 15 is in contact with interior surface of the hollow cylinder 6. The knitted wire cylinder 15 is held in place within the hollow cylinder 6 by friction between the knitted wire cylinder 15 and the hollow cylinder 6, due to the knitted wire cylinder 15 being biased to expand radially outwards, as explained in more detail below. In other embodiments the knitted wire cylinder 15 may be held in place by alternative or additional means, for example by adhesive.

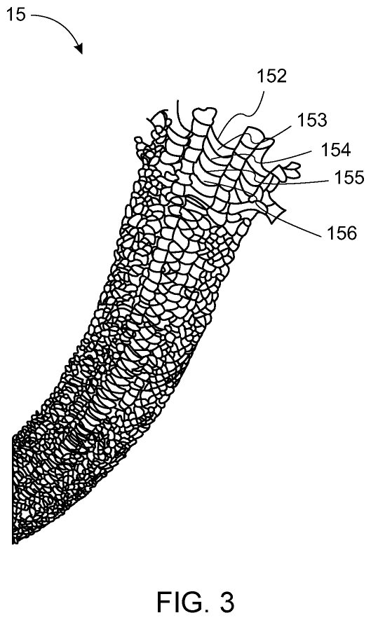

A portion of the knitted wire cylinder 15 is shown in FIG. 3. The knitted wire cylinder 15 is formed of metal wire, though in other embodiments other materials may be used. As can be seen, the knitted wire cylinder 15 comprises a plurality of rows of wire 152 to 156. Each row forms a plurality of loops, which interlock with the loops in the rows above and below. In other words, the knitted wire cylinder 15 is formed by knitting the metal wire to form the interlocked rows 152 to 156. While it cannot be seen in FIG. 3, as is conventional with tubular knitted items, the knitted wire cylinder 15 is formed from a single strand of metal wire, so that each of the rows 152 to 156 is a part of that same strand. Thus, the rows 152 to 156 are in fact adjacent parts of a spiral of wire that forms the cylinder.

When inserting the knitted wire cylinder 15 inside the hollow cylinder 6, a knitted wire cylinder 15 whose exterior diameter is slightly larger than the interior diameter of the hollow cylinder 6 in its relaxed state is used. Prior to insertion within the hollow cylinder 6, the knitted wire cylinder 15 is stretched lengthwise. Due to its knitted structure, this causes the diameter of the knitted wire cylinder 15 to reduce, with the knitted wire cylinder 15 being stretched sufficiently that its exterior diameter becomes less than the interior diameter of the hollow cylinder 6. The knitted wire cylinder 15 is then inserted into the hollow cylinder 6, following which it is released so that it shrinks lengthwise again and expands correspondingly radially until the exterior surface of the knitted wire cylinder 15 is in contact with the interior surface of the hollow cylinder 6. As the original diameter of the knitted wire cylinder 15 was larger than that of the interior of the hollow cylinder 6, the knitted wire cylinder 15 remains biased against the interior surface (i.e. the knitted wire cylinder 15 is biased to expand radially further), with the result that the knitted wire cylinder 15 is held in place within the hollow cylinder 6 by friction.

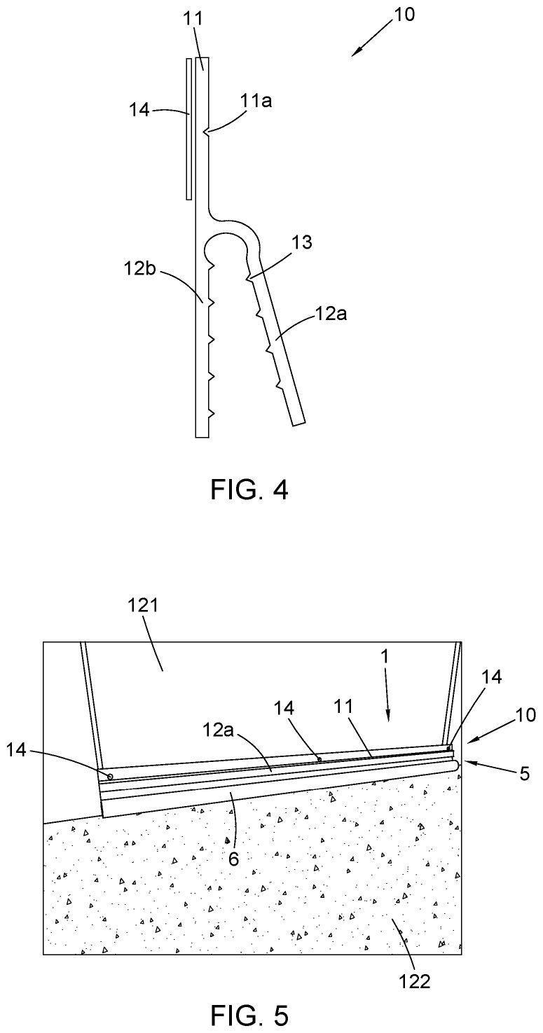

The door seal 1 further comprises a fixing strip 10, shown in FIGS. 1 and 2, and also in more detail in FIG. 4. The fixing strip 10 is formed of aluminium, but in other embodiments other metals or other materials may be used.

The planar strip 7 of the length of elastomeric material 5 is clamped between two “jaws” 12a and 12b of the fixing strip 10. The jaws 12a and 12b have on their inner surfaces multiple “teeth” 13 (in practice V-shaped protrusions from the inside of the jaws 12a and 12b, running along their length), that hold the planar strip 7 in position between the jaws 12a and 12b. FIG. 4 shows the fixing strip 10 after manufacture but before incorporation into the door seal 1, and as can be seen the jaws 12a and 12b are initially angled away from each other to allow the planar strip 7 to be inserted, and are then clamped together over the planar strip 7.

The fixing strip 10 also comprises a fixing portion 11 that extends above the jaws 12a and 12b, for fixing the door seal 1 to a door as explained in more detail below. A V-shaped recess 11a runs along the length of the fixing portion 11, roughly halfway up its height, which is used to mount the door seal 1 to a door as described in more detail below. As can be seen in FIG. 4, on one side of the fixing portion 11 is a layer of contact adhesive 14, which is covered by a removable paper covering.

FIG. 5 is a photograph showing the door seal 1 mounted on the bottom edge of a door 121, to seal a gap between the door 121 and the ground 122. As can be seen, the door seal 1 is fixed to the door 121 by screws 14 screwed through the fixing portion 11 of the fixing strip 10 (the V-shaped recess 11a is not visible in the figure), as well as being fixed in place by the layer of contact adhesive 14 on the side of the fixing portion 11 facing the door 121 (not visible in FIG. 5). As can be seen, the bottom surface of the hollow cylinder 6 is in contact with the ground 122 along its length, so spans the entirety of the gap between the bottom edge of the door 121 and the ground 122. As the hollow cylinder 6 has within it the knitted wire cylinder 15 (also not visible in FIG. 5), the knitted barrier material 15 spans the gap, thus preventing the passage of rodents. Further, as the knitted wire cylinder 15 is formed from by knitting a single metal wire, rodents are not able to remove parts of the knitted barrier material 15 (e.g. individual metal strands), and so the door seal 1 cannot be damaged by rodents to the extent that that are able to pass.

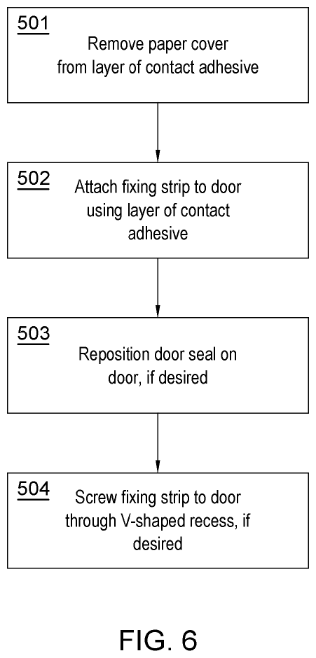

FIG. 6 is a flowchart showing a method of fixing the door seal 1 to a door such as the door 121 in accordance with an embodiment of the invention. In a first step, the removable paper covering is removed from the layer of contact adhesive 14 (step 501). The fixing portion 11 of the fixing strip 10 is then fixed to the door 121 using the layer of contact adhesive 14 (step 502). As at this stage only contact adhesive is used, the door seal 1 can easily be removed and repositioned if required (step 503). Once the door seal 1 is in the desired position, the contact adhesive 14 may be sufficient to permanently mount the door seal 1 in place on the door 121. However, if it is desirable to fix the door seal 1 more securely in place, this can be achieved by screwing one or more screws into the door 121 through the V-spaced recess 11a of the fixing portion 11 (step 504), with the V-spaced recess 11a providing both an area where the material of the fixing potion 11 is thinner, so can be more easily penetrated by a screw, and the V-shape also acts to prevent screws moving out of position as they are being screwed in.

An end cap that can be used with the door seal 1 in another embodiment of the invention is now described with reference to FIGS. 6 and to 8. The end cap 30 is also formed of EPDM rubber, though in other embodiments other materials, including rigid and non-rigid materials, may be used. As can be seen in FIG. 6, the end cap 30 has a body 33, which has a diameter the same as the internal diameter of the hollow cylinder 6, and an end 31 with a flange that extends beyond the body 22.

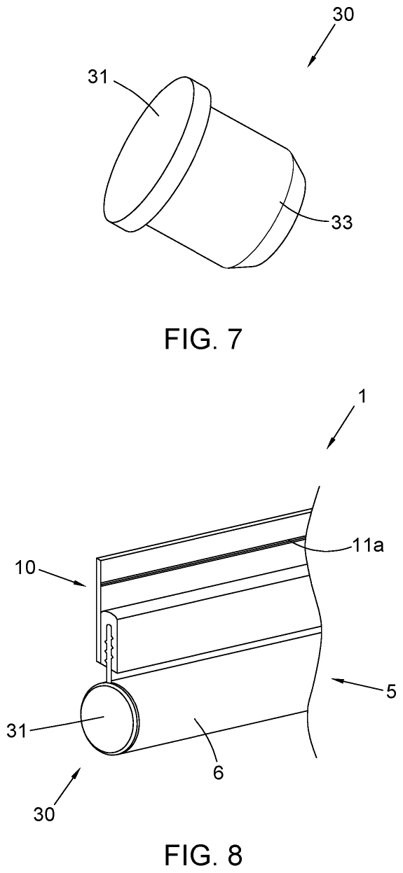

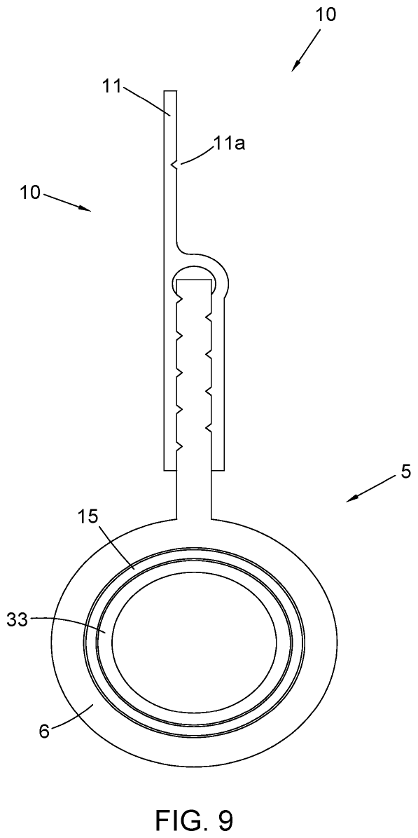

FIGS. 6 and 7 shows the end cap 30 in position in the end of the hollow cylinder 6. As can be seen from FIG. 6, the end cap 30 covers the end of the hollow cylinder 6; and as can be seen in FIG. 7, the end of the knitted wire cylinder 15 is positioned between the body 33 of the end cap 30 and the interior surface of the hollow cylinder 6. As the diameter of the body 33 is the same as the internal diameter of the hollow cylinder 6, the knitted wire cylinder 15 is held in securely position between the hollow cylinder 6 and the body 33 of the end cap 30 by friction, though in other embodiments adhesive may be used in addition.

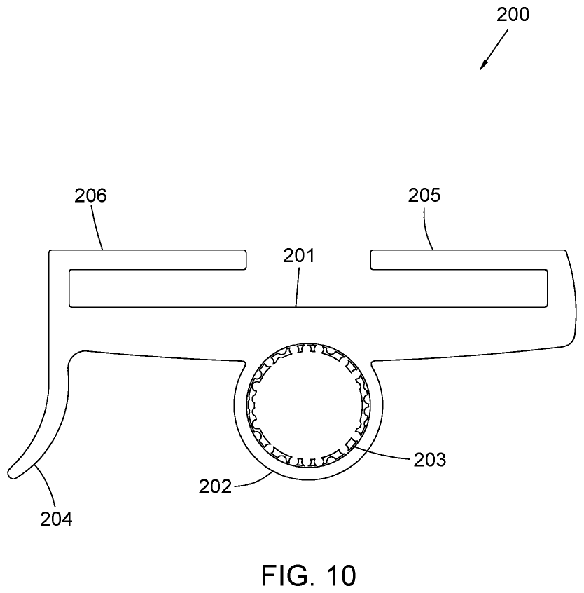

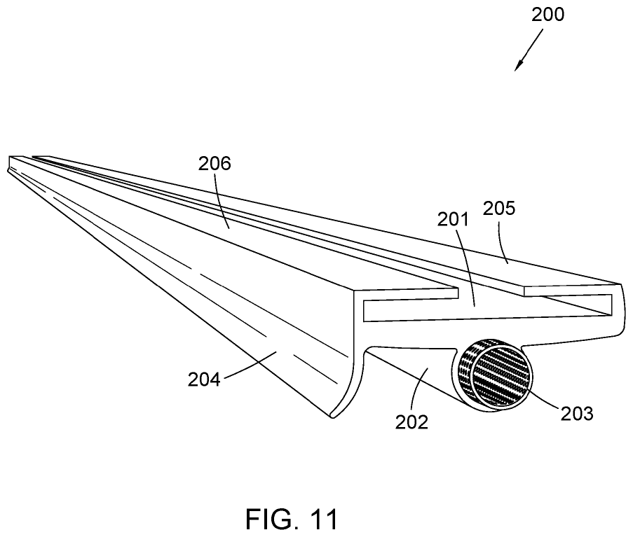

A door seal in accordance with another embodiment of the invention is shown is now described with reference to FIGS. 10 to 12. The door seal 200 comprises a body 201 with in the middle of one side a hollow cylinder 202, which similarly to the above embodiment has within it a knitted wire cylinder 203. On the same side as the hollow cylinder 202, but at one edge of the body 201, is a weather strip 204 that extends out slightly further from the body 201 than the hollow cylinder 202. On the other side of the body 201 are flanges 205 and 206, which extend from the edges of the body 201 towards its middle, to form a gap between the flanges 205 and 206 and the body 201 that is a square C-shape in cross-section.

As in the above embodiment, the hollow cylinder 202 and other parts of the door seal 200, in this case the body 201, weather strip 204, and flanges 205 and 206, are formed of an elastomeric material, which may be extruded as a single piece.

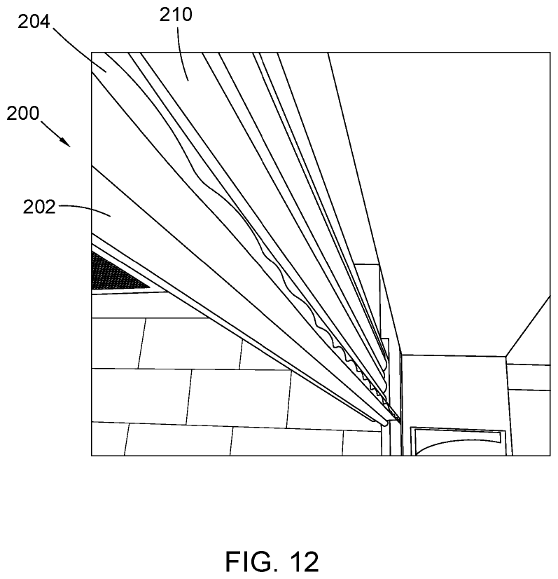

FIG. 12 is a photograph showing the door seal 200 mounted on the bottom edge of a roller door 210. The roller door 210 has a T-shape bottom edge, as is commonly the case with roller doors. The T-shape bottom edge of the door fits within the gap between the flanges 205 and 206 and the body 201, so holding the door seal 200 in place on the bottom edge of the roller door 210. The door seal 200 is oriented on the roller door 210 so that the weather strip 204 is on the exterior side, and can act as a barrier to rain and the like.

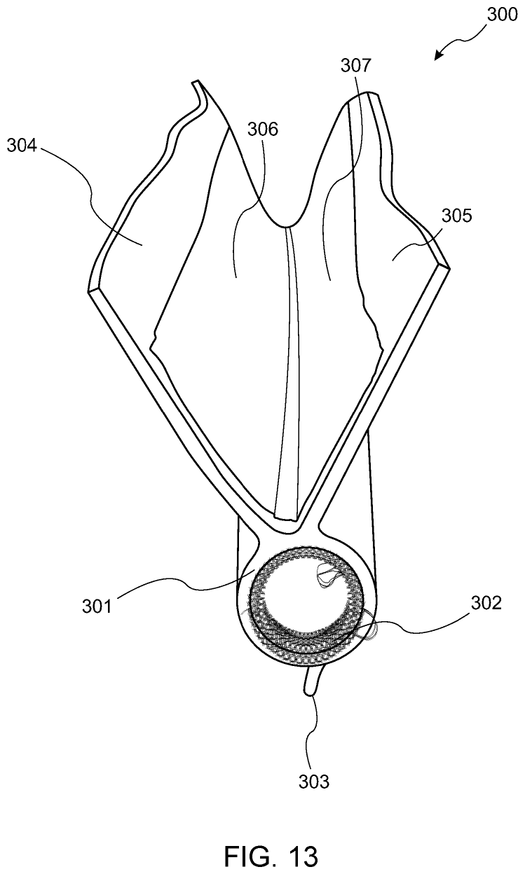

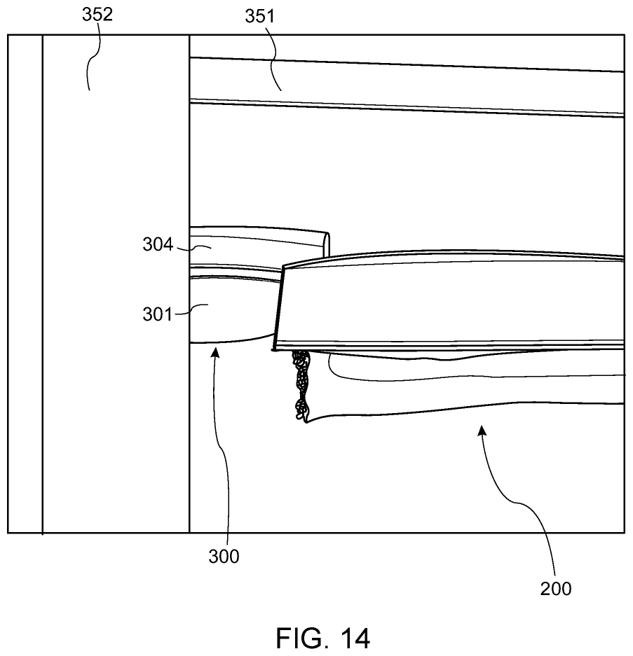

A door seal in accordance with another embodiment of the invention is shown is now described with reference to FIGS. 13 and 14. The door seal 300 comprises a hollow cylinder 301, which similarly to the above embodiments has within it a knitted wire cylinder 302. On one side of the hollow cylinder 301 is a flap 303 extending outwards from the hollow cylinder 301. On the opposite side of the hollow cylinder 301 are a first planar strip 304 and a second planar strip 305, which extend outwards at different directions from the same part of the surface of the hollow cylinder 301, to form a V-shape in cross-section. On the inside surfaces of the first planar strip 304 and the second planar strip 305, i.e. surfaces that face each, is a first layer of contact adhesive 306 and a second layer of contact adhesive 307 respectively.

As in the above embodiment, the hollow cylinder 302 and other parts of the door seal 300, in this case the flap 303, the first planar strip 304 and the second planar strip 305, are formed of an elastomeric material, which may be extruded as a single piece.

FIG. 14 is a photograph showing the door seal 300 mounted on the bottom edge of a roller door 351. As can be seen, the roller door 351 has a door seal 200 in accordance with the above embodiment mounted along most of the length of its bottom edge, but has at its end the door seal 300. The door seal 300 provides a seal for the end of the bottom edge of a roller door 351 where there is no T-shaped bottom edge, and extends into the channel 352 into which the side of the roller door 351 extends to keep the roller door 351 in alignment. The first planar strip 304 is fixed to the outer surface of the roller door 351 by the first layer of contact adhesive 306, and similarly the first planar strip 304 is fixed to the outer surface of the roller door 351 by the first layer of contact adhesive 306 (not visible in FIG. 14).

While the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A door seal for spanning a gap between a door and a surface adjacent to the edge of the door to prevent the passage of rodents, the door seal arranged to be mounted on an edge of the door, the door seal comprising:
a flexible hollow cylinder formed of an elastomeric material;
a cylinder of knitted barrier material positioned inside the flexible hollow cylinder, wherein the exterior surface of the cylinder of knitted barrier material is in contact with the interior surface of the flexible hollow cylinder.

2. A door seal as claimed in claim 1, wherein the cylinder of knitted barrier material is formed of metal wire.

3. A door seal as claimed in claim 1, further comprising a plug positioned in an opening at an end of the flexible hollow cylinder, wherein the corresponding end of cylinder of knitted barrier material is in contact with the exterior surface of the plug so that the knitted barrier material is held in position between the exterior surface of the plug and the interior surface of the flexible hollow cylinder.

4. A door seal as claimed in claim 3, further comprising a second plug positioned in the opening at the opposite end of the flexible hollow cylinder.

5. A door seal as claimed in claim 1, wherein the door seal further comprises a first strip positioned on the exterior surface of the flexible hollow cylinder, and wherein the door seal is arranged to be fixed to the edge of the door by the first strip.

6. A door seal as claimed in claim 5, further comprising a fixing strip fixed to the first strip.

7. A door seal as claimed in claim 6, wherein the first strip is clamped between two surfaces of the fixing strip.

8. A door seal as claimed in claim 6, wherein the fixing strip comprises an area through which the door seal can be screwed to the door.

9. A door seal as claimed in claim 8, wherein the fixing strip further comprises a layer of contact adhesive for gluing the door seal to the door.

10. A door seal as claimed in claim 5, further comprising a second strip positioned on the exterior surface of the flexible hollow cylinder, wherein the door seal is further arranged to be fixed to the edge of the door by the second strip.

11. A door seal as claimed in claim 10, wherein the surface of the first strip facing the second strip comprises a first layer of contact adhesive, and the surface of the second strip facing the first strip comprises a second layer of contact adhesive.

12. A door seal as claimed in claim 5, wherein the flexible hollow cylinder and the first planar portion and/or the second planar portion are formed from the same piece of elastomeric material.

13. A door having mounted on an edge a door seal as claimed in claim 1.

14. A method of mounted a door seal as claimed in claim 9 to the edge of a door, comprising:
attaching the fixing strip of the door seal to the edge of the door using the layer of contact adhesive;
repositioning the fixing strip on the edge of the door; and
once the door seal is in the desired position, screwing one or more screws through the area of the fixing strip into the edge of the door.
